(19) United States
(12) Patent Application Publication
(10) Pub. No.: US 2023/0354920 A1
(43) Pub. Date: Nov. 9, 2023

(54) VAPOR GENERATION DEVICE, SUSCEPTOR, AND PREPARATION METHOD

(71) Applicant: SHENZHEN FIRST UNION TECHNOLOGY CO., LTD., Shenzhen City, Guangdong Province (CN)

(72) Inventors: XIAOFENG TANG, Shenzhen City, Guangdong Province (CN); SAISHENG ZHU, Shenzhen City, Guangdong Province (CN); ZUQIANG QI, Shenzhen City, Guangdong Province (CN); BAOLING LEI, Shenzhen City, Guangdong Province (CN); JIAMAO LUO, Shenzhen City, Guangdong Province (CN); TAO WU, Shenzhen City, Guangdong Province (CN); ZHONGLI XU, Shenzhen City, Guangdong Province (CN); YONGHAI LI, Shenzhen City, Guangdong Province (CN)

(21) Appl. No.: 17/927,524

(22) PCT Filed: May 25, 2021
(86) PCT No.: PCT/CN2021/095820

§ 371 Date: Jun. 26, 2023

(30) Foreign Application Priority Data
May 25, 2020 (CN) 202010451178.3
Aug. 12, 2020 (CN) 202010804879.0

(51) Int. Cl. A24F 40/70; H05B 6/10; A24F 40/42; A24F 40/51

(52) U.S. Cl. CPC A24F 40/70; H05B 6/105; A24F 40/42; A24F 40/51

(57) ABSTRACT

This application discloses a vapor generation device, a susceptor, and a preparation method, including: a cavity, configured to receive the inhalable material; a magnetic field generator, configured to generate a changing magnetic field; a susceptor, configured to be penetrated by the changing magnetic field to generate heat, to heat the inhalable material received in the cavity, where an accommodation cavity extending in a length direction is arranged in the susceptor; and a temperature sensor, configured to sense a temperature of the susceptor and accommodated or encapsulated inside the accommodation cavity. By encapsulating or accommodating a temperature sensor inside a susceptor, an impact of a magnetic field on a sensing portion can be substantially isolated; and on the other hand, the susceptor and the temperature sensor can be integrated to improve stability of installation and accuracy of temperature measurement. Moreover, it is convenient for overall replacement and installation.

### CROSS-REFERENCE TO RELATED APPLICATIONS

This application claims priority to Chinese Patent Application No. 202010451178.3, entitled “VAPOR GENERATION DEVICE, SUSCEPTOR, AND PREPARATION METHOD” filed with the China National Intellectual Property Administration on May 25, 2020, and this application further claims priority to Chinese Patent Application No. 202010804879.0, entitled “VAPOR GENERATION DEVICE AND SUSCEPTOR” filed with the China National Intellectual Property Administration on Aug. 12, 2020, which is incorporated herein by reference in this application.

### TECHNICAL FIELD

This application relates to the field of heat not burning e-cigarette technologies, and in particular, to a vapor generation device, a susceptor, and a preparation method.

### BACKGROUND

Tobacco products (for example, cigarettes and cigars) burn tobacco during use to produce tobacco smoke. Attempts are made to replace these products that burn tobacco by manufacturing products that release compounds without burning.

An example of such a product is a heating device that releases a compound by heating rather than burning a material. For example, the material may be tobacco or other non-tobacco products, where the non-tobacco products may or may not contain nicotine. As another example, the prior art proposes a heating device of electromagnetic induction heating type, where the structure of the device may refer to FIG. 1. When a tobacco product 1 is received in the heating device, a susceptor 2 is penetrated by an alternating magnetic field generated by an induction coil 3 to implement induction heating, thereby heating the tobacco product 1. In order to facilitate real-time monitoring of a heating temperature for the tobacco product 1 during the heating process, the heating device uses a temperature sensor 4 that is closely attached to the susceptor 2 to sense a real-time operating temperature of the susceptor 2, and adjusts a parameter of the alternating magnetic field generated by the induction coil 3 according to a sensed result of the temperature sensor 4 to make the susceptor 2 be within an appropriate heating temperature range.

In the above implementation of the temperature detection of the temperature sensor 4, on one hand, since the temperature sensor 4 is usually made of a thermistor metal material, which generates heat under an alternating magnetic field; and on the other hand, the temperature sensor 4 and the susceptor 2 made of a metal material each generate an induced current, which affects a sensing signal outputted by the temperature sensor 4 and affects an accuracy of the sensing signal.

### SUMMARY

In order to resolve the problem of accuracy of temperature monitoring of a vapor generation device in the prior art, this application provides a vapor generation device, a susceptor, and a preparation method.

A vapor generation device provided in this application is configured to heat an inhalable material to generate an aerosol, and the device includes:
a cavity, configured to receive the inhalable material;
a magnetic field generator, configured to generate a changing magnetic field;
a susceptor, configured to be penetrated by the changing magnetic field to generate heat, to heat the inhalable material received in the cavity, where an accommodation cavity extending in a length direction is arranged in the susceptor; and a temperature sensor, configured to sense a temperature of the susceptor and accommodated or encapsulated inside the accommodation cavity.

Further, the susceptor is formed into a sheet shape extending in an axial direction of the cavity, and includes a first sheet-like body and a second sheet-like body opposite to each other in a thickness direction, where
the first sheet-like body is connected to the second sheet-like body.

Further, the first sheet-like body includes: a first part extending straight in the axial direction of the cavity, and a second part formed by at least a part of the first part protruding outward in the thickness direction; and
the accommodation cavity is formed between the second part of the first sheet-like body and the second sheet-like body.

Further, the first sheet-like body further includes a third part formed by the first part extending outward in a width direction, to support or hold the susceptor by the third part.

Further, the cavity includes an opening end that removably receives the inhalable material; and
a protrusion height of at least a part of the second part relative to the first part gradually decreases in a direction of getting closer to the opening end.

Further, at least a part of a third part of the first sheet-like body protrudes relatively to other parts in the thickness direction.

Further, the second part is formed in a manner that a cross section is substantially a triangle or circular arc.

Further, the second sheet-like body includes: a fourth part extending straight in the axial direction of the cavity, and a fifth part formed by at least a part of the fourth part protruding outward in the thickness direction; and
the fifth part is arranged opposite to the second part, and the accommodation cavity is formed between the fifth part and the second part.

Further, the temperature sensor further includes a conductive connection portion at least partially penetrating from inside of the accommodation cavity to outside of the susceptor, so that a temperature sensed by the temperature sensor is capable of being received through the conductive connection portion during use.

Further, the second part of the first sheet-like body is formed by punching a flat sheet-like metal or metal plate material.

Further, the cavity includes an opening end that removably receives the inhalable material; and
at least a part of the accommodation cavity is formed into a tapered region that is gradually smaller in a direction of getting closer to a cross-sectional area of the opening end;
and the temperature sensor is accommodated or encapsulated in the tapered region.

Further, the susceptor is formed into a sheet shape extending in the axial direction of the cavity, and includes a first surface and a second surface facing away from each other in a thickness direction, and the first surface and the second surface are flat surfaces, where
the accommodation cavity is located between the first surface and the second surface.

Further, the susceptor includes a first sheet-like part and a second sheet-like part opposite to each other in the thickness direction, and the accommodation cavity is formed by defining between the first sheet-like part and the second sheet-like part.

Further, the first sheet-like part and the second sheet-like part are formed by folding a sheet-like body around an axis.

Further, the first sheet-like part and the second sheet-like part are symmetrical with respect to the axis.

Further, the sheet-like body is prepared by chemical etching.

Further, the sheet-like body includes a dent arranged along the axis.

Further, the first sheet-like part forms the first surface along an outer surface in the thickness direction, and the second sheet-like part forms the second surface along an outer surface in the thickness direction; and

the accommodation cavity is formed between an inner surface of the first sheet-like part in the thickness direction and an inner surface of the second sheet-like part in the thickness direction.

Further, the accommodation cavity includes a first groove extending along the inner surface of the first sheet-like part in the thickness direction;

and/or, the accommodation cavity includes a second groove extending along the second sheet-like part and the inner surface of the second sheet-like part in the thickness direction.

Further, the first sheet-like part and/or the second sheet-like part further includes a base part extending outward in a width direction, so as to support or hold the susceptor by the base part.

Further, the temperature sensor includes a first couple wire and a second couple wire made of different materials.

This application further provides a susceptor for a vapor generation device, the susceptor being configured to be penetrated by a changing magnetic field to generate heat to heat an inhalable material, where the susceptor is formed into a sheet shape, the susceptor includes an accommodation cavity extending in a length direction, and the accommodation cavity is configured to accommodate or encapsulate a temperature sensor configured to sense a temperature of the susceptor.

Further, the susceptor includes a first surface and a second surface facing away from each other in a thickness direction, and the first surface and the second surface are flat surfaces, where the accommodation cavity is located between the first surface and the second surface.

Further, the susceptor includes a first sheet-like body and a second sheet-like body opposite to each other in the thickness direction; and the first sheet-like body is connected to the second sheet-like body to form the accommodation cavity.

This application further provides a preparation method for a susceptor for a vapor generation device, where the susceptor is configured to be penetrated by a changing magnetic field to generate heat to heat an inhalable material, and the method includes the following steps:
providing a first sheet-like body and a second sheet-like body opposite to each other in a thickness direction, and forming an accommodation cavity extending in a length direction between the first sheet-like body and the second sheet-like body; and accommodating or encapsulating, inside the accommodation cavity, a temperature sensor configured to sense a temperature of the susceptor.

According to the above vapor generation device, susceptor, and preparation method in this application, by encapsulating or accommodating the temperature sensor inside the susceptor, on one hand, an impact of a magnetic field on a sensing portion can be substantially isolated; and on the other hand, the susceptor and the temperature sensor can be integrated to improve stability of installation and accuracy of temperature measurement. Moreover, it is convenient for overall replacement and installation.

### BRIEF DESCRIPTION OF THE DRAWINGS

One or more embodiments are exemplarily described with reference to the corresponding figures in the accompanying drawings, and the descriptions are not to be construed as limiting the embodiments. Components in the accompanying drawings that have same reference numerals are represented as similar components, and unless otherwise particularly stated, the figures in the accompanying drawings are not drawn to scale.

FIG. 1 is a schematic structural diagram of an existing heating device of electromagnetic induction heating type;

FIG. 2 is a schematic structural diagram of a vapor generation device according to an embodiment of this application;

FIG. 3 is a schematic structural diagram of a susceptor in FIG. 2 from a perspective;

FIG. 4 is a schematic exploded view of parts of the susceptor in FIG. 3 before assembly;

FIG. 5 is a schematic diagram of a susceptor according to another embodiment;

FIG. 6 is a schematic diagram of a susceptor according to still another embodiment;

FIG. 7 is a schematic diagram of a susceptor according to still another embodiment;

FIG. 8 is a schematic diagram of a preparation method of a susceptor according to an embodiment;

FIG. 9 is a schematic structural diagram of a susceptor in a vapor generation device according to another embodiment of this application;

FIG. 10 is a schematic diagram of a susceptor precursor formed by etching on a sheet-like substrate during preparation of a susceptor according to an embodiment;

FIG. 11 is a schematic structural diagram of a susceptor precursor in FIG. 10;

FIG. 12 is a schematic diagram of a susceptor formed by folding after a temperature sensor is arranged in a susceptor precursor;

FIG. 13 is a schematic structural diagram of a susceptor precursor according to still another embodiment;

FIG. 14 is a schematic structural diagram of a susceptor precursor according to still another embodiment;

FIG. 15 is a schematic diagram of covering an etching mask on a sheet-like substrate in preparation of a susceptor according to another embodiment; and

FIG. 16 is a schematic diagram of a susceptor prepared by welding a thermocouple after etching according to another embodiment.

### DETAILED DESCRIPTION

For ease of understanding of this application, this application is described below in more detail with reference to accompanying drawings and specific implementations.

### Embodiment 1

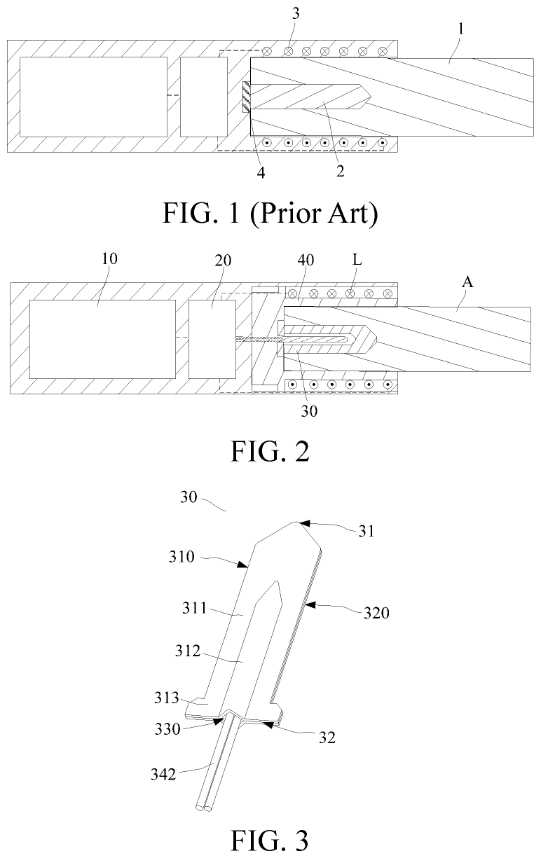

A vapor generation device provided in this embodiment of this application has a structure shown in FIG. 2, and includes:
a cavity, in which an inhalable material A such as a cigarette is removably received inside;
an inductance coil L, used as a magnetic field generator and configured to generate an alternating magnetic field under an alternating current;
a susceptor 30, at least a part of which extends in the cavity, and which is configured to be inductively coupled to the inductance coil L and penetrated by the alternating magnetic field to generate heat to heat the inhalable material A, so that at least one component of the inhalable material A is volatilized, forming an aerosol for inhalation;
a battery cell 10, which is a rechargeable direct current battery cell and can provide a direct voltage and a direct current; and
a circuit 20, which is electrically connected to the rechargeable battery cell 10, and is configured to convert the direct current outputted by the battery cell 10 into an alternating current with a suitable frequency and supply the alternating current to the inductance coil L.

According to settings of a product in use, the inductance coil L may include a cylindrical inductor coil wound into a spiral shape as shown in FIG. 2. The cylindrical inductance coil L wound into a spiral shape may have a radius r ranging from about 5 mm to about 10 mm, and in particular, the radius r may be about 7 mm. A length of the cylindrical inductance coil L wound into a spiral shape may range from about 8 mm to about 14 mm, and a number of turns of the inductance coil L may range from about 8 to 15. Correspondingly, an inner volume may range from about 0.15 cm3 to about 1.10 cm3.

In a more preferred implementation, a frequency of the alternating current supplied to the inductance coil L by the circuit 20 ranges from 80 KHz to 400 KHz. More specifically, the frequency may range from about 200 KHz to 300 KHz.

In a preferred embodiment, a direct current voltage provided by the battery cell 10 ranges from about 2.5 V to about 9.0 V, and an amperage of the direct current by which the battery cell 10 can provide ranges from about 2.5 A to about 20 A.

In the preferred embodiment, the susceptor 30 in FIG. 2 is prepared by a metal or alloy material with appropriate magnetic permeability, so that induction heating corresponding to a magnetic field can be formed during use, thereby heating the received inhalable material A to generate an aerosol for inhalation. These susceptors 30 may be made of grade 420 stainless steel (SS420) and alloy materials including iron and nickel (such as J85/J66 Permalloy).

In an embodiment shown in FIG. 2, the vapor generation device further includes a tubular holder 40 for arranging the inductance coil L and installing the susceptor 30. Materials of the tubular holder 40 may include a high temperature resistant non-metal material such as PEEK or ceramic. In an implementation, the inductance coil L is arranged on an outer wall of the tubular holder 40 in a spiral winding manner, and at least a part of the tubular holder 40 is hollow to form the cavity configured to receive the inhalable material A.

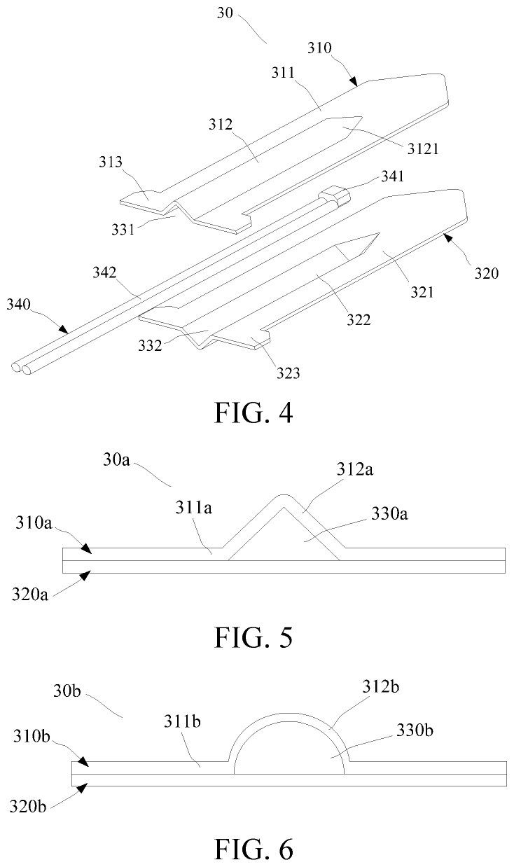

Further, referring to FIG. 3 and FIG. 4, a sheet-like construction of the susceptor 30 has a first end 31 and a second end 32. The first end 31 is opposite to an opening the cavity configured to receive the inhalable material A. The first end 31, as a free end, is formed into a tip shape to facilitate insertion into the inhalable material A received in the cavity through an opening end, and the second end 32, as an end portion for installation and connection, is configured to provide support through the tubular holder 40 to enable the susceptor 30 to be stably held, installed, and fixed in the device.

In a more preferred implementation, a construction of the susceptor 30 is formed by a first sheet-like body 310 and a second sheet-like body 320 opposite to each other in a thickness direction together. Specifically,
the first sheet-like body 310 includes a flat first part 311, a second part 312 formed by the first part 311 protruding outward in the thickness direction, and a third part 313 formed by at least a part of the first part 311 close to the second end 32 extending in a width direction.

The shape corresponding to the second sheet-like body 320 is similar to that of the first sheet-like body 310, likewise including a flat fourth part 321, a fifth part 322 formed by the fourth part 321 protruding outward in the thickness direction, and a sixth part 323 formed by at least a part of the fourth part 321 close to the second end 32 extending in the width direction.

After the first sheet-like body 310 is combined with the second sheet-like body 320, an accommodation cavity 330 configured to accommodate and encapsulate a temperature sensor 340 is formed between them. Specifically, the accommodation cavity 330 is formed by a first sunken structure 331 formed by the second part 312 of the first sheet-like body 310 and a second sunken structure 332 formed by the fifth part 322 of the second sheet-like body 320 together.

During assembly, a sensing part 341 of the temperature sensor 340 is accommodated and encapsulated inside the accommodation cavity 330 and may be encapsulated and fixed through gluing or the like. In addition, an electrical connection part 342 of the temperature sensor 340 passes through the second end 32 from the inside of the accommodation cavity 330 to the outside of the susceptor 30 in a form of being designed into an elongated pin, thereby facilitating the connection to the circuit 20, and then the circuit 20 may receive a sensing signal of the sensing part 341 through the electrical connection part 342. During use, the temperature sensor 40 is encapsulated inside the accommodation cavity 330 that is substantially shielded by a magnetic field, and the sensing part 341 closely abuts against the first sheet-like body 310 and/or the second sheet-like body 320, so as to stably or accurately detect the temperature of the susceptor 30 and avoid interference of the magnetic field.

In an optional implementation, the temperature sensor 340 may be a thermistor type temperature sensor, such as PT1000, that calculates a temperature by monitoring changes in a resistor, or may be a thermocouple type temperature sensor that calculates a temperature by calculating thermoelectromotive force of two ends.

Based on an intention of mass production and preparation of the susceptor 30, furthermore, in a preferred implementation, the second part 312 of the first sheet-like body 310 and/or the fifth part 322 of the second sheet-like body 320 is formed or prepared by stamping the above flat sheet-like susceptive material such as a metal plate member. In addition, in a stable engagement, the first sheet-like body 310 and the second sheet-like body 320 may be fixed as a whole by welding such as laser welding.

In a preferred implementation shown in FIG. 3 and FIG. 4, the accommodation cavity 330 extends in an axial direction of the susceptor 30. In the implementation, a cross section of the accommodation cavity 330 may substantially be rhombic, circular, rectangular, or in other shapes.

According to FIG. 4, the second part 312 has a tapered portion 3121 with a gradually decreasing cross-sectional area as getting closer to the first end 31 of the susceptor 30, for example, the tapered portion 3121 has a cone shape, triangular cone shape, or the like. And, the second part 312 is configured to reduce resistance during being inserted into the inhalable material A.

In a more preferred implementation, the tapered portion 3121 of the second part 312, or the combination with the corresponding fifth part 322 with a similar configuration may cause a formed front end part of the accommodation cavity 330 close to the first end 31 to be a tapered shape. In the installation, the sensing part 341 of the temperature sensor 340 abuts against the tapered front end part of the accommodation cavity 330, so as to facilitate fastening and installation.

According to the preferred implementation shown in the figures, the thickness-direction size of a part in the susceptor 30 forming the accommodation cavity 330 and composed of the second part 312 and the fifth part 322 is greater than other parts in the susceptor 30. In addition, a thickness size of the accommodation cavity 330 formed by the second part 312 and the fifth part 322 gradually increases inward in the width direction, so that an outer surface of the susceptor 30 formed by the second part 312 and the fifth part 322 changes gradually. On one hand, a contact area with the inhalable material A is increased to improve efficiency of heat transfer; and on the other hand, the resistance of inserting the susceptor 30 into the inhalable material A may be reduced.

In another optional implementation shown in FIG. 5 or FIG. 6, a second sheet-like body 320a/320b of the susceptor 30a/30b is a flat shape. And, only a second part 312a/312b formed by stamping or the like on the first sheet-like body 310a/310b and protruding outward in the thickness direction exists, and an accommodation cavity 330a/330b for accommodating or encapsulating the temperature sensor is formed between the second part 312a/312b and second sheet-like body 320a/320b.

Certainly, according to the implementation shown in FIG. 5 or FIG. 6, a shape of a cross section of the second part 312a/312b may substantially be a triangle or circular arc shape with a thickness size gradually increasing inward in the width direction. In addition, it may be seen from FIG. 5 and FIG. 6 that, a protrusion size of the second part 312a/312b in the thickness direction is greater than the thickness size of the first part 311a/311b.

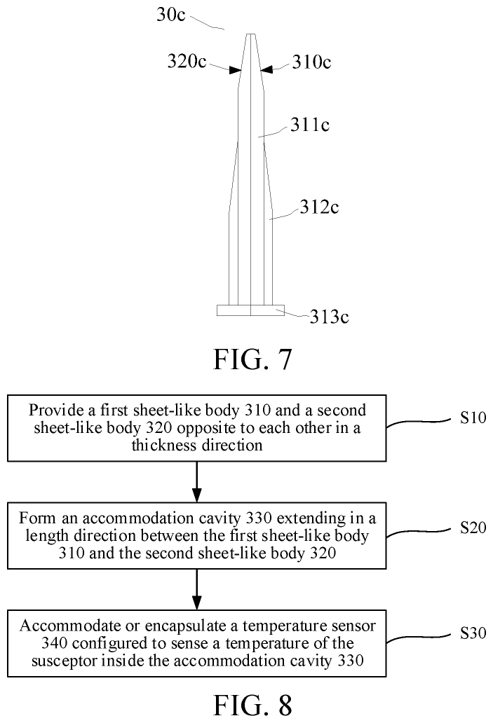

In another variation implementation shown in FIG. 7, a thickness of a third part 313c of a first sheet-like body 310c of a susceptor 30c along the susceptor 30c has a greater size than a first part 311c and a second part 312c, so that the third part 313c protrudes relative to other parts on the thickness direction, so as to facilitate installation and holding inside the device.

### Embodiment 2

This application further proposes a method for preparing the susceptor in Embodiment 1. Referring to FIG. 8, method steps including the following steps:

S10: Provide a first sheet-like body 310 and a second sheet-like body 320 opposite to each other in a thickness direction.

S20: Form an accommodation cavity 330 extending in a length direction between the first sheet-like body 310 and the second sheet-like body 320.

S30: Acquire a temperature sensor 340, and accommodate or encapsulate the temperature sensor 340 inside the accommodation cavity 330.

### Embodiment 3

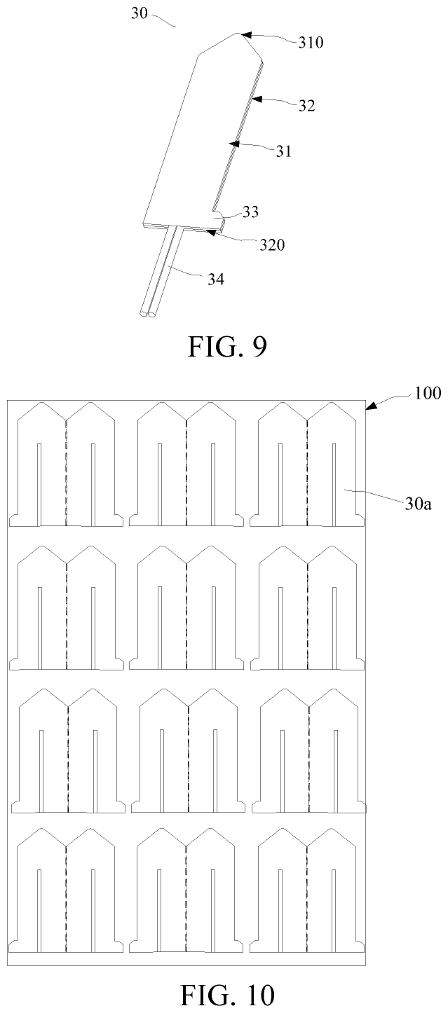

This application further provides a vapor generation device. Unlike the vapor generation device provided in Embodiment 1, referring to FIG. 9, in order to facilitate support and fixation for a second end 320, at least a part of a susceptor 30 close to the second end 320 has a base part 33 with an enlarged size. For example, the base part 33 is enlarged in a width direction.

Further, referring to FIG. 9, an accommodating space or a holding space is provided inside the susceptor 30, and is configured to accommodate, encapsulate, or hold a temperature sensor 34 extending in a length direction. The temperature sensor 34 is configured to sense a temperature of the susceptor 30 during operation. In a preferred implementation shown in FIG. 9, at least a part of the temperature sensor 34 extends from the second end 320, so as to facilitate connection to a circuit 20. A part of the temperature sensor 34 extending or exposed outside the susceptor 30 is in a form of an elongated pin.

In an optional implementation, the temperature sensor 34 may be a thermistor type temperature sensor, such as PT1000, that calculates a temperature by monitoring changes in a resistor or a thermocouple type temperature sensor that calculates a temperature by calculating thermoelectromotive force of two ends.

Specifically, in a preferred implementation shown in FIG. 10, the sheet-like susceptor 30 is formed by stacking a first sheet-like part 31 and a second sheet-like part 32 in the thickness direction.

In the implementation shown in FIG. 9, an outer surface of the sheet-like susceptor 30 is flat.

This application further proposes a method suitable for mass preparation of the above susceptor 30, the method specifically including the following steps:

S10: Acquire a sheet-like sensing substrate 100 for preparing a susceptor 30a, and process the sheet-like sensing substrate 100 to form several susceptor precursors 30a, as shown in FIG. 10.

In the implementation, the material of the sheet-like sensing substrate 100 is the above-described metal material having susceptibility, such as a 0.5 mm thick NiFe alloy soft magnetic board. A manner of processing to form the susceptor precursor 30a may include a manner of chemical etching, and the susceptor precursor 30a is formed after the superfluous part is etched and removed.

Certainly, in the preferred implementation shown in FIG. 10, based on convenience of batch preparation, the several susceptor precursors 30a obtained by processing are arranged in a matrix.

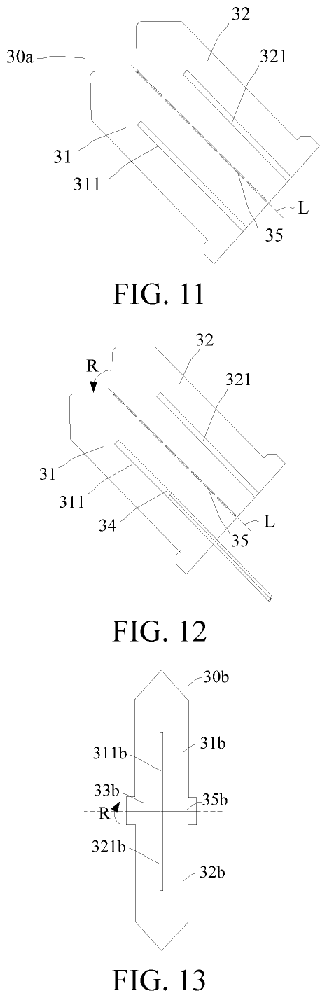

A specific structure of the susceptor precursor 30a further refers to FIG. 11, including a first sheet-like part 31 and a second sheet-like part 32 on the same plane. The first sheet-like part 31 and the second sheet-like part 32 are connected rather than separated. In addition, the first sheet-like part 31 and the second sheet-like part 32 are symmetrical, and specifically, are bilaterally symmetrical along a central axis L in FIG. 12.

Further, a first accommodation groove 311 for accommodating and holding the temperature sensor 34 is arranged on the first sheet-like part 31, or a second accommodation groove 321 for accommodating and holding the temperature sensor 34 may be further arranged on the second sheet-like part 32.

S20: As shown in FIG. 12, the temperature sensor 34 is placed into the first accommodation groove 311 of the first sheet-like part 31, the second sheet-like part 32 is turned over or folded towards the first sheet-like part 31 along a direction of an arrow R around the central axis L, the temperature sensor 34 is clamped or fixed between the first sheet-like part 31 and the second sheet-like part 32 after the second sheet-like part 32 is turned over, and then the first sheet-like part 31 is combined stably with the second sheet-like part 32 through laser welding or the like. In this way, the susceptor 30 shown in FIG. 3 is obtained.

In a preferred implementation shown in FIG. 11 and FIG. 12, for ease of turning over the second sheet-like part 32 towards the first sheet-like part 31, several dents or grooves 35 arranged around the central axis L are arranged on the susceptor precursor 30a. The susceptor precursor 30a with the dents or grooves 35 is conducive to the operation process of turning over or folding.

FIG. 13 is a schematic structural diagram of a susceptor precursor 30b according to another variation implementation. The susceptor precursor 30b includes a first sheet-like part 31b and a second sheet-like part 32b opposite to each other in a length direction. In addition, the susceptor precursor 30b further includes a dent 35b located between the first sheet-like part 31b and the second sheet-like part 32b in the length direction, where the dent 35b extends in the width direction. During preparation, the susceptor is obtained by turning over or folding the first sheet-like part 31b towards the second sheet-like part 32b with the dent 35b as an axis. Certainly, a first accommodation groove 311b accommodating the temperature sensor 34 is further arranged on the first sheet-like part 31b; and/or, a second accommodation groove 321b is further arranged on the second sheet-like part 32b.

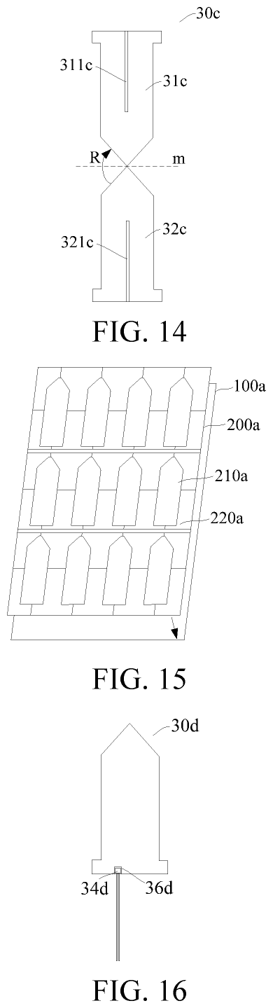

Alternatively, in a variation implementation shown in FIG. 14, a first sheet-like part 31c and a second sheet-like part 32c of a susceptor precursor 30c is obtained by fixing after turning over with a dashed line m as an axis.

In the above optional implementations, the susceptor 30 is about 19 mm in length, 4.9 mm in width, and about 0.5 mm in width. Correspondingly, an extending length of the first accommodation groove 311/311b/311c and/or the second accommodation groove 321/321b/321c extending from the second end 320 to the first end 310 is about one-half to two-thirds of a length of the susceptor 30. A region of this length is a region where heat is most concentrated in the susceptor 30 during operation. When a front end of the temperature sensor 34 abuts against this region, the temperature of the susceptor 30 can be obtained more accurately.

In another optional implementation, the first accommodation groove 311/311b/311c and/or the second accommodation groove 321/321b/321c is about 0.1 mm in depth.

### Embodiment 4

This application further proposes a method for preparing the susceptor in Embodiment 3, the method including the following steps:

S100: Acquire a sheet-like substrate 100a made of a susceptive material, and cover an etching mask 200a on a surface of the sheet-like substrate 100, as shown in FIG. 15.

Generally, a feeding material of the sheet-like substrate 100a is a coil, and a board cut into the above size from the coil has a certain bending degree. It is necessary to shape the coil by an appropriate pressure (usually less than 10 MPa) before use, so that a curved metal coil is subjected to a certain plastic deformation, and is shaped into a flat sheet-like substrate 100a from a curved metal coil.

According to FIG. 15, a light-painted film is used as the etching mask 200a in photochemical etching generally. In addition, the etching mask 200a includes a pattern 210a having the same shape with the susceptor, and a non-pattern blank region 220a.

S200: Etch the sheet-like substrate 100a covered with the etching mask 200a. An acid etching liquid, for example, an etching liquid including hydrofluoric acid, is generally used to etch.

During etching, a part of the sheet-like substrate 100a covered with the pattern 210a is not corroded, while a part corresponding to the blank region 220a is corroded and removed. After the etching is completed, several susceptors identical to the pattern 210a are formed on the sheet-like substrate 100a; and the susceptors may be lightly broken off manually to be detached, thereby obtaining a large number of prepared susceptors.

Usually, when a sheet-like substrate 100a with a length and width dimension of 250 mm×120 mm is used as the material for preparation, one sheet-like substrate 100a may be etched to obtain 100 to 200 susceptors simultaneously.

Compared with machining, stamping, or laser cutting, in a case of preparing the susceptor by etching, the etching processing does not generate processing stress on one hand, and does not cause a crystalline phase structure of the internal substrate to change on the other hand, so that the prepared susceptor can maintain magnetic properties comparable to those of soft magnetic materials, thereby having high heating efficiency in use.

For the susceptor obtained by etching processing, an edge of the obtained susceptor has smooth rounded corners, and a smooth surface of the edge has low surface free energy, which is conducive to reducing adhesion of slag or condensate of a vapor generation product, while the aesthetic of a surface is maintained.

In another preferred implementation of this application, the etching process in the above step is performed by conventional photochemical wet etching. Detailed steps include:

S110: Prepare the etching mask 200a, that is, the film, by light-painting according to a shape and pattern of a to-be-prepared susceptor.

S120: After coating photosensitive ink on the sheet-like substrate 100a, pre-dry the sheet-like substrate with hot air at a temperature ranging from 30° C. to 40° C. for 10 to 15 minutes, so as to cure the photosensitive ink to prevent the film from sticking in subsequent film development.

S130: Adhere the film onto the sheet-like substrate 100a coated with the photosensitive ink for exposure processing. Exposure may usually be performed by using a high voltage mercury lamp, iodine gallium lamp, or metal halide lamp to irradiate for about twenty seconds.

During the exposure, a part of the coated photosensitive ink corresponding to the pattern 210a of the film is sensed, thereby generating a polymerization cross-linked reaction to form a cured protective film layer. A part corresponding to the blank region 220a of the film is not polymerized and cross-linked to form curing.

S140: Develop: soak with a developing liquid after the film is removed. Specifically, the sheet-like substrate 100a is soaked using a 1% aqueous sodium carbonate solution or directly using water at a temperature ranging from 25° C. to 30° C. In this way, the photosensitive ink that is not cross-linked and cured is dissolved and removed by the developing liquid, a protective film layer is formed on the part corresponding to the pattern 210a on a surface of the sheet-like substrate 100a, and the part corresponding to the blank region 220a of the film is exposed.

S150: The sheet-like substrate 100a developed according to the curing effect may be further cured with supplementary light and dried again. The curing with supplementary light and drying processing enhance a bonding force between the protective film layer and the sheet-like substrate 100a, and improve performance of corrosion resistance. If a photosensitive ink with good adhesive capability and curing capability is used, step S150 may be omitted.

S210: Etch the sheet-like substrate 100a prepared in the above steps by using a strong acid etching liquid. An etching speed is 0.04 mm/min, and the faster the etching speed is, the side etching degree is less.

S220: Perform de-filming processing after the etching in S210 is completed. An aqueous 20% sodium hydroxide solution is used for soaking for ten minutes at a temperature ranging from 50° C. to 60° C. to dissolve the protective film layer, then several susceptors arranged in a matrix are obtained by washing, and then a large number of single susceptors are obtained by manual separation and sampling.

### Embodiment 5

This application further proposes a susceptor 30d prepared by the preparation method in Embodiment 4. As shown in FIG. 16, the susceptor 30d is provided with a notch 36d. Subsequently, a first couple wire and a second couple wire made of different materials are welded onto an inner wall of the notch 36d by laser welding, thereby forming a thermocouple 34d configured to sense a temperature of the susceptor 30d.

In an optional implementation, a nickel chromium alloy wire is used as the first couple wire of the thermocouple 34d as a positive electrode, and a K-type thermocouple made of a nickel silicon alloy wire is used as the second couple wire as a negative electrode.

In the embodiments of this application, by encapsulating or accommodating the temperature sensor inside the susceptor, on one hand, an impact of a magnetic field on a sensing portion can be substantially isolated; and on the other hand, the susceptor and the temperature sensor can be integrated to improve stability of installation and accuracy of temperature measurement. Moreover, it is convenient for overall replacement and installation.

It should be noted that, preferable embodiments of this application are provided in the specification and its accompanying drawings, but this application is not limited to the embodiments described in the specification. Further, a person of ordinary skill in the art may make improvements or modifications according to the foregoing descriptions, and all of the improvements and modifications should all fall within the protection scope of the attached claims of this application.

1. A vapor generation device, configured to heat an inhalable material to generate an aerosol, the device comprising:
a cavity, configured to receive the inhalable material;
a magnetic field generator, configured to generate a changing magnetic field;
a susceptor, configured to be penetrated by the changing magnetic field to generate heat to heat the inhalable material received in the cavity, wherein an accommodation cavity extending in a length direction is arranged in the susceptor; and
a temperature sensor, configured to sense a temperature of the susceptor and accommodated or encapsulated inside the accommodation cavity.

2. The vapor generation device according to claim 1, wherein the susceptor is formed into a sheet shape extending in an axial direction of the cavity, and comprises a first sheet-like body and a second sheet-like body opposite to each other in a thickness direction;
wherein the first sheet-like body is connected to the second sheet-like body.

3. The vapor generation device according to claim 2, wherein the first sheet-like body comprises: a first part extending straight in the axial direction of the cavity, and a second part formed by at least a part of the first part protruding outward in the thickness direction; and
the accommodation cavity is formed between the second part of the first sheet-like body and the second sheet-like body.

4. The vapor generation device according to claim 3, wherein the first sheet-like body further comprises a third part formed by the first part extending outward in a width direction, to support or hold the susceptor by the third part.

5. The vapor generation device according to claim 3, wherein the cavity comprises an opening end that removably receives the inhalable material; and
a protrusion height of at least a part of the second part relative to the first part gradually decreases in a direction of getting closer to the opening end.

6. The vapor generation device according to claim 5, wherein at least a part of a third part of the first sheet-like body protrudes relatively to other parts in the thickness direction.

7. The vapor generation device according to claim 3, wherein the second part is formed in a manner that a cross section is substantially a triangle or circular arc.

8. The vapor generation device according to claim 3, wherein the second sheet-like body comprises: a fourth part extending straight in the axial direction of the cavity, and a fifth part formed by at least a part of the fourth part protruding outward in the thickness direction; and
the fifth part is arranged opposite to the second part, and the accommodation cavity is formed between the fifth part and the second part.

9. The vapor generation device according to claim 3, wherein the temperature sensor further comprises a conductive connection portion at least partially penetrating from inside of the accommodation cavity to outside of the susceptor, so that a temperature sensed by the temperature sensor is capable of being received through the conductive connection portion during use.

10. The vapor generation device according to claim 3, wherein the second part of the first sheet-like body is formed by punching a flat sheet-like metal or metal plate material.

11. The vapor generation device according to claim 2, wherein:
the cavity comprises an opening end that removably receives the inhalable material; and
at least a part of the accommodation cavity is formed into a tapered region a cross-sectional area of which is gradually smaller in a direction of getting closer to the opening end; and the temperature sensor is accommodated or encapsulated in the tapered region.

12. The vapor generation device according to claim 1, wherein the susceptor is formed into a sheet shape extending in an axial direction of the cavity, and comprises a first surface and a second surface facing away from each other in a thickness direction, and the first surface and the second surface are flat surfaces; wherein
the accommodation cavity is located between the first surface and the second surface.

13. The vapor generation device according to claim 12, wherein the susceptor comprises a first sheet-like part and a second sheet-like part opposite to each other in the thickness direction, and the accommodation cavity is formed by defining between the first sheet-like part and the second sheet-like part.

14. The vapor generation device according to claim 13, wherein the first sheet-like part and the second sheet-like part are formed by folding a sheet-like body around an axis.

15. The vapor generation device according to claim 13, wherein the first sheet-like part and the second sheet-like part are symmetrical with respect to the axis.

16. The vapor generation device according to claim 13, wherein the sheet-like body is prepared by chemical etching.

17. The vapor generation device according to claim 13, wherein the sheet-like body comprises a dent arranged along the axis.

18. The vapor generation device according to claim 13, wherein the first sheet-like part forms the first surface along an outer surface in the thickness direction, and the second sheet-like part forms the second surface along an outer surface in the thickness direction; and
the accommodation cavity is formed between an inner surface of the first sheet-like part in the thickness direction and an inner surface of the second sheet-like part in the thickness direction.

19. The vapor generation device according to claim 18, wherein the accommodation cavity comprises a first groove extending along the inner surface of the first sheet-like part in the thickness direction;
and/or, the accommodation cavity comprises a second groove extending along the inner surface of the second sheet-like part in the thickness direction.

20. The vapor generation device according to claim 13, wherein the first sheet-like part and/or the second sheet-like part further comprises a base part extending outward in a width direction, so as to support or hold the susceptor by the base part.

21-25. (canceled)
